(19) United States
(12) Patent Application Publication
(10) Pub. No.: US 2024/0163093 A1
(43) Pub. Date: May 16, 2024

(54) GENERAL ACCESS STRUCTURE SECRET SHARING USING AUTHENTIC GARBLED CIRCUITS

(71) Applicant: VMware LLC, Palo Alto, CA (US)

(72) Inventor: Avishay Yanai, Herzliya (IL)

(21) Appl. No.: 18/056,177

(22) Filed: Nov. 16, 2022

(51) Int. Cl. H04L 9/08

(52) U.S. Cl. CPC H04L 9/088

(57) ABSTRACT

An improved general access structure secret sharing (GAS-SS) scheme that leverages an authentic garbled circuit protocol is provided. With this improved scheme, GAS-SS can be implemented more efficiently than existing schemes that rely on more complex and expensive cryptographic primitives.

### BACKGROUND

Unless specifically indicated herein, the approaches described in this section should not be construed as prior art to the claims of the present application and are not admitted to be prior art by inclusion in this section.

Secret sharing is a cryptographic scheme that allows a party, referred to as a dealer, to distribute a secret among a group of other parties, referred to as receivers, in a secure manner. Secret sharing proceeds according to two phases: a sharing phase during which the dealer divides the secret into a number of shares and provides a share to each receiver, and a reconstruction phase during which some subset of receivers attempt to reconstruct (and thereby reveal) the secret by combining their respective shares. The shares are designed such that no receiver can learn anything regarding the secret solely from his/her individual share, but the secret can be reconstructed if a sufficient number or permutation of receivers combine their shares.

According to one type of secret sharing scheme known as (t,n) threshold secret sharing, at least t out of n total receivers must agree to reveal the secret in order to reconstruct it using their respective shares. In other words, any subset of t or more receivers can reconstruct the secret by combining their shares, whereas no subset of fewer than t receivers can.

According to another type of secret sharing scheme known as general access structure secret sharing (GAS-SS), the dealer defines the specific subsets of receivers that are authorized to reconstruct the secret using their shares. These subsets of receivers are referred to as qualified sets. For example, consider a secret sharing scenario with a total of five receivers R₁, R₂, R₃, R₄, and R₅. In this scenario, the dealer may define three qualified sets (R₁,R₃,R₅), (R₁,R₃,R₄), and (R₂,R₅) such that only these subsets of receivers may combine their shares to successfully reconstruct the secret during the reconstruction phase. Any other subset, such as (R₁,R₂,R₃), will not be able to do so.

GAS-SS is relevant to many real-world applications where different receivers may have different levels of privilege/authorization with respect to their ability to reconstruct the secret. However, an issue with existing GAS-SS implementations is that they generally rely on complex and expensive cryptographic primitives, resulting in high resource overhead and/or slow performance.

### BRIEF DESCRIPTION OF THE DRAWINGS

FIG. 1 depicts an example Boolean circuit.

FIGS. 2A and 2B depict the sharing and reconstruction phases of a GAS-SS scheme.

FIG. 3 depicts a sharing phase workflow of a garbled circuit-based GAS-SS scheme according to certain embodiments.

FIG. 4 depicts a reconstruction phase workflow of a garbled circuit-based GAS-SS scheme according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

Embodiments of the present disclosure are directed to an improved general access structure secret sharing (GAS-SS) scheme that leverages an authentic garbled circuit protocol (referred to herein as garbled circuit-based GAS-SS). A garbled circuit protocol is a cryptographic protocol that allows two parties to jointly compute a function over inputs that are private to each party, where the function is represented as a Boolean circuit. An authentic garbled circuit protocol is a garbled circuit protocol that exhibits the property of authenticity, which means that the output of a garbled circuit evaluated via the protocol cannot be forged.

Sections (1)-(3) below present an overview of Boolean circuits, garbled circuit protocols, and authentic garbled circuit protocols to provide context for the garbled circuit-based GAS-SS scheme of the present disclosure. Section (4) then presents the details of this scheme, including example sharing phase and reconstruction phase workflows.

### 1. Boolean Circuit

A Boolean circuit is a mathematical representation of a function that is composed of a set of gates coupled via wires that carry a bit value of zero or one. Generally speaking, each gate is a Boolean function ƒ(x,y)→z where x and y are bit values carried on the gate's incoming wires and z is a bit value carried on the gate's outgoing wire. Examples of such Boolean functions include logical AND, logical OR, logical XOR, and so on. The input to a Boolean circuit is a bit string carried over the set of wires that are not output by any gate of the circuit (referred to as the circuit's input wires), and the output of a Boolean circuit is a bit string carried over the set of wires that are not used as input to any gate of the circuit (referred to as the circuit's output wires).

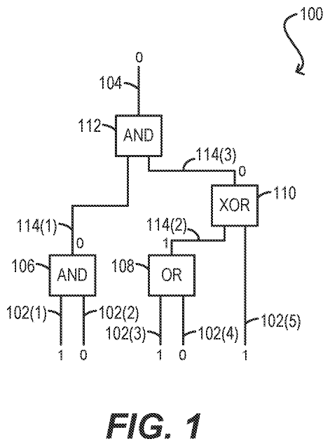

By way of example, FIG. 1 depicts a simple Boolean circuit 100 comprising five input wires 102(1)-(5), one output wire 104, and four gates 106-112 (AND gate 106, OR gate 108, XOR gate 110, and AND gate 112) that are interconnected via intermediary wires 114(1)-(3). In this example, the bit string “10101” is provided as input to circuit 100 over input wires 102(1)-(5), which causes circuit 100 to output the bit string “0” over output wire 104 in accordance with the circuit's structure.

In particular, bit values “1” and “0” are provided over input wires 102(1) and 102(2) as inputs to AND gate 106, resulting in an output of “0” on intermediary wire 114(1). Further, bit values “1” and “0” are provided over input wires 102(3) and 102(4) as inputs to OR gate 108, resulting in an output of “1” on intermediary wire 114(2). Yet further, bit values “0” and “1” are provided over intermediary wire 114(2) and input wire 102(5) as inputs to XOR gate 110, resulting in an output of “0” on intermediary wire 114(3). Finally, bit values “0” and “0” are provided over intermediary wires 114(1) and 114(3) as inputs to AND gate 112, resulting in an output of “0” on output wire 104.

### 2. Garbled Circuit Protocol

A garbled circuit protocol is a cryptographic protocol that enables secure two-party computation over a function that is represented as a Boolean circuit. This protocol is composed of the following algorithms:
Garble(C)→F,e,d—This algorithm takes as input a description of a Boolean circuit C comprising n input wires and m output wires and outputs a garbled circuit F, encoding information e, and decoding information d. Garbled circuit F is a garbled (i.e., encrypted) version of Boolean circuit C. Encoding information e is a set of n label pairs (L₀¹,L₁¹,L₀²,L₁², . . . , L₀ⁿ,L₁ⁿ) corresponding to the n input wires of C, where the L₀ⁱ label in the i-th label pair is a randomly-selected value/string that represents a bit value of “0” over input wire i and the L₁ⁱ label in the i-th label pair is a randomly-selected value/string that represents a bit value of “1” over input wire i.
Encode (e,x₁,x₂, . . . , xₙ)→X—This algorithm takes as input encoding information e and an n-length bit string x₁,x₂, . . . , xₙ representing an input to Boolean circuit C and outputs a set of n labels X that are mapped to x₁, x₂, . . . , xₙ in accordance with e. In particular, the i-th label in label set X is either the “zero label” (i.e., L₀ⁱ) or “one label” (i.e., L₁ⁱ) for xᵢ as defined in encoding information e, based on the bit value of xᵢ (zero or one). Stated more formally, X=(Lₓ_{₁}¹,Lₓ_{₂}², . . . , Lₓ_{ₙ}ⁿ). For example, assume n=5 and (x₁,x₂,x₃,x₄,x₅)=(0,1,1,1,0). In this case, X will equal (L₀¹,L₁²,L₁³,L₁⁴,L₀⁵). X is also referred to as a garbled input for Boolean circuit C because it hides the true input bit values by replacing them with their corresponding labels.
Evaluate(F,X)→—This algorithm takes as input garbled circuit F and garbled input X and outputs a garbled output Y indicating the result of evaluating F using X.
Decode(Y,d)→y—This algorithm takes as input garbled output Y and decoding information d and outputs an output value y.

A proper garbled circuit protocol implementation exhibits the properties of correctness and privacy. With respect to the correctness property, assume y′ is the result of evaluating Boolean circuit C on the input bit string x₁, x₂, . . . , xₙ (i.e., C(x₁, x₂, . . . , xₙ)→y′). In this case, correctness guarantees that if C and x₁, x₂, . . . , xₙ are provided as input to the Garble algorithm and the Encode, Evaluate, and Decode algorithms are executed faithfully based on the outputs of Garble, output value y of the Decode algorithm will equal y′.

The privacy property guarantees that a party that is given garbled circuit F and garbled input X and executes the Evaluate and/or Decode algorithms to obtain output value y will not learn anything other than y. For example, the party will not learn anything regarding the original input bit values x₁, x₂, . . . , xₙ.

With the foregoing in mind, the protocol typically proceeds as follows:
1. A first party P1 garbles a Boolean circuit C using the Garble algorithm and encodes a subset of an input bit string x₁, x₂, . . . , xₙ corresponding to P1's private inputs for C using the Encode algorithm.
2. P1 sends garbled circuit F and their encoded inputs (i.e., labels) to a second party P2.
3. P2 communicates with P1 (via, e.g., oblivious transfer) to encode the subset of input bit string x₁, x₂, . . . , xₙ corresponding to P2's private inputs for C and assembles garbled input X.
4. P2 evaluates garbled circuit F using garbled input X using the Evaluate algorithm.
5. P2 provides garbled output Y to P1.
6. P1 decodes garbled output Y using the Decode algorithm to obtain/learn output value y. Per the correctness property noted above, y will be equivalent to the output of evaluating Boolean circuit C using input bit string x₁, x₂, . . . , xₙ (which corresponds to the combined private inputs of P1 and P2). Further, per the privacy property noted above, P1 will not learn anything regarding P2's private portion of the input bit string and P2 will not learn anything regarding P1's private portion of the input bit string.

### 3. Authentic Garbled Circuit Protocol

An authentic garbled circuit protocol is a garbled circuit protocol that also exhibits the property of authenticity (in addition to correctness and privacy). In the protocol description above with parties P1 and P2, authenticity guarantees that at step (5), P2 cannot provide to P1 a garbled output Y′≠Y such that Decode(Y′,d) produces a valid output value y. Stated another way, P2 cannot forge the garbled output by replacing it with something else that allows the protocol to complete successfully.

A corollary of this authenticity property is the following—assume output value y is a single bit value (i.e., either “0” or “1”); this means that Evaluate (F,X) will result in one of two garbled outputs: Y₀ which decodes to y=0, or Y₁ which decodes to y=1. In this scenario, if P2 executes Evaluate (F,X) in accordance with step (4) and the garbled output is Y₀, P2 is guaranteed to not learn anything regarding the other possible garbled output Y₁ (and vice versa). This is because if P2 could learn the other garbled output Y₁, P2 could return Y₁ instead of the correct garbled output Y₀ at step (5), which would allow the Decode algorithm to generate a valid output value of y=1 and thus violate the authenticity property.

### 4. GAS-SS Using an Authentic Garbled Circuit Protocol

As mentioned in the Background section, a secret sharing scheme allows a dealer to securely share a secret among a set of receivers by sending a portion (i.e., share) of the secret to each receiver. An individual receiver cannot learn anything regarding the secret using only his/her share; however, a subset of the receivers can reconstruct the secret using their respective shares if one or more conditions are met.

General access structure secret sharing (GAS-SS) is particular type of secret sharing scheme in which a subset of receivers can reveal the secret if and only if that subset is authorized to do so by the dealer. Such an authorized subset is known as a qualified set and the set of qualified sets for a secret sharing is known as an access structure (denoted by the symbol F).

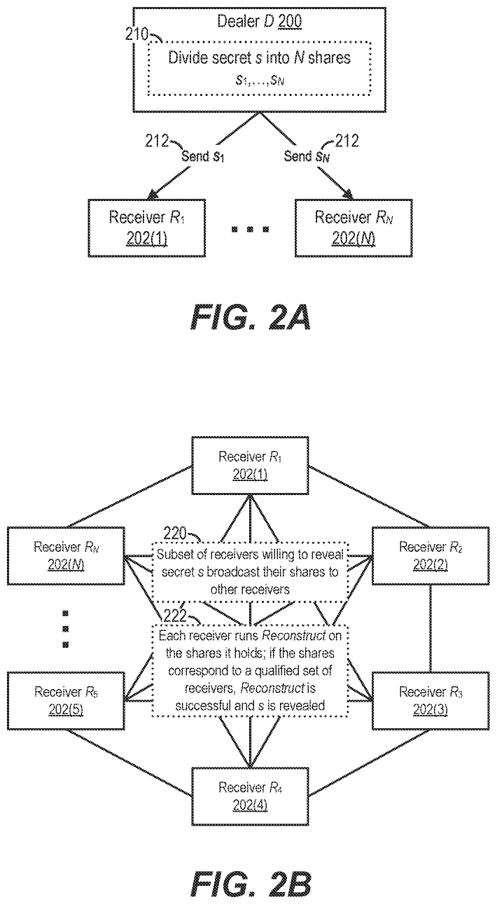

By way of example, FIGS. 2A and 2B depict a dealer D (reference numeral 200) and a set of N receivers R=(R₁, R₂, . . . , R_{N}) (reference numerals 202(1)-(N)).that participate in a GASS-SS scheme. Dealer D and each receiver Rᵢ may be a computing device, such as a physical or virtual computer system.

In particular, FIG. 2A illustrates the execution of a sharing phase of the GAS-SS scheme in which dealer D divides secret s into N shares s₁, s₂, . . . , s_{N} (reference numeral 210) and sends a share sᵢ to each receiver Rᵢ (reference numeral 212). And FIG. 2B illustrates the execution of a reconstruction phase of the GAS-SS scheme in which the subset of receivers willing to reveal secret s broadcast their shares to the other receivers (reference numeral 220) and each receiver subsequently runs a Reconstruct algorithm on the shares that it holds (reference numeral 222). If the held shares correspond to a qualified set of receivers as defined by dealer D, the Reconstruct algorithm will be successful and secret s will be revealed; otherwise, the Reconstruct algorithm will fail and s will remain private.

GAS-SS is an important building block for other cryptographic schemes and applications such as secure multi-party computation (MPC), secure storage of data, user authentication, and so on. However, existing GAS-SS implementations rely on complex and expensive cryptographic primitives like public/private key encryption that often result in high overhead and poor performance.

To address this, embodiments of the present disclosure provide an improved GAS-SS scheme that employs an authentic garbled circuit protocol (i.e., garbled circuit-based GAS-SS). Such authentic garbled circuit protocols are generally simpler in design than other cryptographic primitives, thereby allowing for better efficiency and performance. This scheme leverages the observation that every access structure F for the sharing of a secret s among a set of N receivers R via GAS-SS can be represented by a Boolean circuit C_{Γ} which:
takes as input N input bit values x^{R}′=(x₁^{R}′, . . . , x_{N}^{R}′) corresponding to a subset of receivers R′⊆R (where xᵢ^{R}′=1 if receiver Rᵢ ∈R′ and xᵢ^{R}′=0 if receiver Rᵢ ∉R′); and
outputs 1 if R′∈Γ and 0 if R′∉Γ.

With this Boolean circuit C_{Γ}, the garbled circuit-based GAS-SS scheme of the present disclosure can generally proceed as follows:
1. During the sharing phase, the dealer can run the Garble algorithm of an authentic garbled circuit protocol on circuit C_{Γ} to obtain garbled circuit F and encoding information e. In addition, the dealer can encrypt secret s using Y₁ (i.e., the garbled output of F that decodes to y=1) to generate a ciphertext ct. The dealer can then send, to each receiver Rᵢ, F, ct, and the label pair for that receiver as defined in e (i.e., (L₀ⁱ,L₁ⁱ)).
2. During the reconstruction phase, each receiver Rᵢ can inform the other receivers of whether it wants to reveal/reconstruct secret s or not by (A) broadcasting its zero label L₀ⁱ to the other receivers (and to itself) if it doesn't want to reveal s, and (B) broadcasting its one label L₁ⁱ to the other receivers (and to itself) if it wants to reveal s. Each receiver can then compile garbled input X based on the labels it has, run Evaluate (F,X)→Y (where Y∈{Y₀,Y₁} per the definition of circuit C_{Γ}), and attempt to decrypt ciphertext ct using Y. If Y=Y₁ (which means that the subset of receivers that want to reveal secret s is a qualified set), the decryption operation will be successful and the receivers will be able to reveal s. Conversely, if Y=Y₀ (which means that the subset of receivers that want to reveal the secret is not a qualified set), the decryption operation will fail because it requires Y₁, not Y₀, as the decryption key and thus the receivers will not be able to reveal s.

Significantly, due to the property of authenticity described in section (3) above, the receivers will not be able to learn anything regarding Y₁ by running the Evaluate algorithm of the authentic garbled circuit protocol on garbled circuit F and garbled input X in the case where Evaluate outputs Y₀. Accordingly, garbled circuit-based GAS-SS ensures that secret s cannot be revealed by the receivers if only an unqualified set wants to do so, because an unqualified set will not be able to obtain decryption key Y₁.

The remaining subsections of the present disclosure provide example workflows for implementing the sharing and reconstruction phases of garbled circuit-based GAS-SS according to certain embodiments. It should be appreciated that the foregoing description and figures are illustrative and not intended to limit embodiments of the present disclosure. For example, details such as specific algorithm names (e.g., Garble, Encode, Evaluate, Decode, etc.) are provided for explanation purposes only and can be changed without affecting the algorithms' functionalities. One of ordinary skill in the art will recognize other variations, modifications, and alternatives.

### 4.1 Sharing Phase

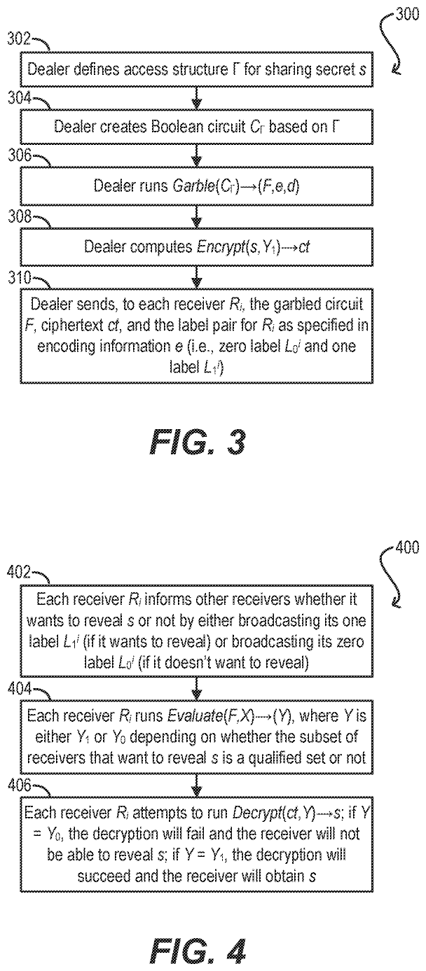

FIG. 3 depicts a workflow 300 that may be executed by a dealer D during the sharing phase of garbled circuit-based GAS-SS for sharing a secret s among a set of N receivers according to certain embodiments.

Starting with step 302, dealer D can define an access structure F for the sharing of secret s. As explained previously, this access structure is the set of qualified receiver sets that can reconstruct s using their respective shares. For example, if there is a total of five receivers R₁, R₂, R₃, R₄, and R₅, dealer D may define access structure F as including three qualified sets (R₁,R₃,R₅), (R₁,R₃,R₄), and (R₂,R₅) such that only these particular subsets of receivers may combine their shares to successfully reconstruct secret s during the reconstruction phase.

At step 304, dealer D (or some other entity) can create a Boolean circuit C_{Γ} based on access structure Γ that takes as input N bit values x^{R}′=(x₁^{R}′, . . . , x_{N}^{R}′) corresponding to a subset of receivers R′⊆R (where xᵢ^{R}′=1 if receiver Rᵢ∈R′ and xᵢ^{R}′=0 if receiver Rᵢ∈R′) and outputs 1 if R′∈Γ (thereby indicating that R′ is a qualified set) and 0 if R′∈Γ (thereby indicating that R′ is not a qualified set). Dealer D can then run, via an authentic garbled circuit protocol, Garble(C_{Γ})→F, e, d where F is the garbled version of Boolean circuit C_{Γ} and where e is encoding information comprising N label pairs corresponding to the N receivers (step 306). For example, encoding information e can include a first label pair (L₀¹,L₁¹) for the first receiver R₁, a second label pair (L₀²,L₁²) for the second receiver R₂, and so on. Each label of a label pair can be a random value/string.

At step 308, dealer D can compute Encrypt(s,Y₁)→ct, or in other words encrypt secret s using Y₁ (i.e., the garbled output of F that will decode to y=1) as a symmetric key, resulting in ciphertext ct. This means that Y₁ will be needed to decrypt ciphertext ct back into secret s.

Finally at step 310, dealer D can send to each receiver Rᵢ the garbled circuit F, ciphertext ct, and the label pair for that receiver (as specified in encoding information e) according to the receiver's index i. For example, dealer D can send label pair (L₀¹,L₁¹) in encoding information e to receiver R₁, (L₀²,L₁²) in e to receiver R₂, and so on.

### 4.2 Reconstruction Phase

FIG. 4 depicts a workflow 400 that may be executed by each receiver Rᵢ during the reconstruction phase of garbled circuit-based GAS-SS according to certain embodiments. This workflow assumes that the sharing phase described in workflow 300 has already been executed, and thus each receiver Rᵢ has garbled circuit F, ciphertext ct, and its label pair (L₀ⁱ,L₁ⁱ).

Starting with step 402, each receiver Rᵢ can inform the other receivers whether it wants to reveal secret s or not. In particular, if receiver Rᵢ wants to reveal secret s, it can broadcast its one label L₁ⁱ to the other receivers and to itself. If receiver Rᵢ does not want to reveal secret s, it can broadcast its zero label L₀ⁱ to the other receivers and to itself. Upon completion of this step, every receiver will have a set of labels X comprising, for each input wire i of garbled circuit F, one label out of the two possible labels for that input wire indicating whether receiver Rᵢ wants reveal s.

For example, assume there are three receivers R₁, R₂, and R₃ and R₁ does not want to reveal secret s while R₂ and R₃ do. In this scenario, upon the completion of step 402, each receiver will have garbled circuit F, ciphertext ct, and the set of labels X=(L₀¹,L₁²,L₁³).

At step 404, each receiver Rᵢ can run, via the authentic garbled circuit protocol, Evaluate(F,X)→Y where garbled output Y∈{Y₀,Y₁}. Whether Y equals Y₀ or Y₁ will depend on whether the subset of receivers that want to reveal the secret (and thus have broadcast its one label at step 402) is a qualified set or not; if they are a qualified set, the latter will be true, otherwise the former will be true.

Finally, upon obtaining garbled output Y, each receiver Rᵢ can attempt to decrypt ciphertext ct using Y as the decryption key (i.e., compute Decrypt(ct,Y)) (step 406). If Y=Y₀, which means the subset of receivers that want to reveal secret s is not a qualified set, this decryption operation will fail because it requires Y₁ as the decryption key, and thus the receivers will not be able to reveal s. This is the correct outcome per the definition of general access structure secret sharing. As mentioned previously, in this scenario Y₁ cannot be learned by the receivers per the authenticity property of the authentic garbled circuit protocol, which thus prevents secret s from being leaked to, e.g., an adversary.

On the other hand if Y=Y₁, which means the subset of receivers that want to reveal secret s is a qualified set, the decryption operation at step 406 will be successful and the receivers will be able to reveal s. This is also a correct outcome because a qualified set of receivers should be able to reveal/reconstruct the secret per the definition of general access structure secret sharing.

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
defining, by a computer system acting as a dealer in a general access structure secret sharing (GAS-SS) scheme, an access structure for sharing a secret among N receivers, wherein the access structure identifies one or more qualified sets of the N receivers that are authorized to reveal the secret;
creating, by the computer system, a Boolean circuit that represents the access structure, wherein the Boolean circuit takes as input N input bit values corresponding to the N receivers, each input bit value having a value of zero if its corresponding receiver does not wish to reveal the secret during a reconstruction phase of the GAS-SS scheme and a value of one if its corresponding receiver wishes to reveal the secret during the reconstruction phase, and wherein the Boolean circuit generates an output bit value of zero if a subset of the N receivers that wish to reveal the secret as indicated by the N input bit values is not a qualified set and generates an output bit value of one if the subset of the N receivers that wish to reveal the secret as indicated by the N input bit values is a qualified set;
executing, by the computer system, a garble algorithm of an authentic garbled circuit protocol on the Boolean circuit, the executing of the garble algorithm resulting in a garbled circuit and encoding information specifying N label pairs corresponding to the N receivers;
encrypting, by the computer system, the secret using a garbled output Y₁, the encrypting resulting in a ciphertext; and
sending, by the computer system to each receiver in the N receivers, the garbled circuit, the ciphertext, and a label pair for the receiver as specified in the encoding information.

2. The method of claim 1 wherein the garbled output Y₁ is generated by an evaluate algorithm of the authentic garbled circuit protocol in a scenario where the evaluate algorithm receives as input the garbled circuit and a garbled input encoding a set of N input bit values corresponding to a qualified set of the N receivers.

3. The method of claim 1 wherein the label pair for the receiver includes a zero label representing an input bit value of zero for the receiver and a one label representing an input bit value of one for the receiver.

4. The method of claim 3 wherein upon receiving the garbled circuit, the ciphertext, and the label pair, each receiver:
informs other receivers in the N receivers whether the receiver wishes to reveal the secret or not.

5. The method of claim 4 wherein each receiver informs the other receivers by:
sending to the other receivers the receiver's one label if the receiver wishes to reveal the secret; and
sending to the other receivers the receiver's zero label of the receiver does not wish to reveal the secret.

6. The method of claim 4 wherein each receiver further:
compiles a garbled input based on labels received from the other receivers; and
executes a evaluate algorithm of the authentic garbled circuit protocol on the garbled circuit and the garbled input, the executing of the evaluate algorithm resulting in a garbled output Y.

7. The method of claim 6 wherein each receiver further:
attempts to decrypt the ciphertext using the garbled output Y as a decryption key.

8. A non-transitory computer readable storage medium having stored thereon program code executable by a computer system acting as a dealer in a general access structure secret sharing (GAS-SS) scheme, the program code embodying a method comprising:
defining an access structure for sharing a secret among N receivers, wherein the access structure identifies one or more qualified sets of the N receivers that are authorized to reveal the secret;
creating a Boolean circuit that represents the access structure, wherein the Boolean circuit takes as input N input bit values corresponding to the N receivers, each input bit value having a value of zero if its corresponding receiver does not wish to reveal the secret during a reconstruction phase of the GAS-SS scheme and a value of one if its corresponding receiver wishes to reveal the secret during the reconstruction phase, and wherein the Boolean circuit generates an output bit value of zero if a subset of the N receivers that wish to reveal the secret as indicated by the N input bit values is not a qualified set and generates an output bit value of one if the subset of the N receivers that wish to reveal the secret as indicated by the N input bit values is a qualified set;
executing a garble algorithm of an authentic garbled circuit protocol on the Boolean circuit, the executing of the garble algorithm resulting in a garbled circuit and encoding information specifying N label pairs corresponding to the N receivers;
encrypting the secret using a garbled output Y₁, the encrypting resulting in a ciphertext; and
sending, to each receiver in the N receivers, the garbled circuit, the ciphertext, and a label pair for the receiver as specified in the encoding information.

9. The non-transitory computer readable storage medium of claim 8 wherein the garbled output Y₁ is generated by an evaluate algorithm of the authentic garbled circuit protocol in a scenario where the evaluate algorithm receives as input the garbled circuit and a garbled input encoding a set of N input bit values corresponding to a qualified set of the N receivers.

10. The non-transitory computer readable storage medium of claim 8 wherein the label pair for the receiver includes a zero label representing an input bit value of zero for the receiver and a one label representing an input bit value of one for the receiver.

11. The non-transitory computer readable storage medium of claim 10 wherein upon receiving the garbled circuit, the ciphertext, and the label pair, each receiver:
informs other receivers in the N receivers whether the receiver wishes to reveal the secret or not.

12. The non-transitory computer readable storage medium of claim 11 wherein each receiver informs the other receivers by:
sending to the other receivers the receiver's one label if the receiver wishes to reveal the secret; and
sending to the other receivers the receiver's zero label of the receiver does not wish to reveal the secret.

13. The non-transitory computer readable storage medium of claim 11 wherein each receiver further:
compiles a garbled input based on labels received from the other receivers; and
executes a evaluate algorithm of the authentic garbled circuit protocol on the garbled circuit and the garbled input, the executing of the evaluate algorithm resulting in a garbled output Y.

14. The non-transitory computer readable storage medium of claim 13 wherein each receiver further:
attempts to decrypt the ciphertext using the garbled output Y as a decryption key.

15. A computer system acting as a dealer in a general access structure secret sharing (GAS-SS) scheme, the computer system comprising:
a processor; and
a non-transitory computer readable medium having stored thereon program code that, when executed, causes the processor to:
define an access structure for sharing a secret among N receivers, wherein the access structure identifies one or more qualified sets of the N receivers that are authorized to reveal the secret;
create a Boolean circuit that represents the access structure, wherein the Boolean circuit takes as input N input bit values corresponding to the N receivers, each input bit value having a value of zero if its corresponding receiver does not wish to reveal the secret during a reconstruction phase of the GAS-SS scheme and a value of one if its corresponding receiver wishes to reveal the secret during the reconstruction phase, and wherein the Boolean circuit generates an output bit value of zero if a subset of the N receivers that wish to reveal the secret as indicated by the N input bit values is not a qualified set and generates an output bit value of one if the subset of the N receivers that wish to reveal the secret as indicated by the N input bit values is a qualified set;
execute a garble algorithm of an authentic garbled circuit protocol on the Boolean circuit, the executing of the garble algorithm resulting in a garbled circuit and encoding information specifying N label pairs corresponding to the N receivers;
encrypt the secret using a garbled output Y₁, the encrypting resulting in a ciphertext; and
send, to each receiver in the N receivers, the garbled circuit, the ciphertext, and a label pair for the receiver as specified in the encoding information.

16. The computer system of claim 15 wherein the garbled output Y₁ is generated by an evaluate algorithm of the authentic garbled circuit protocol in a scenario where the evaluate algorithm receives as input the garbled circuit and a garbled input encoding a set of N input bit values corresponding to a qualified set of the N receivers.

17. The computer system of claim 15 wherein the label pair for the receiver includes a zero label representing an input bit value of zero for the receiver and a one label representing an input bit value of one for the receiver.

18. The computer system of claim 17 wherein upon receiving the garbled circuit, the ciphertext, and the label pair, each receiver:
informs other receivers in the N receivers whether the receiver wishes to reveal the secret or not.

19. The computer system of claim 18 wherein each receiver informs the other receivers by:
sending to the other receivers the receiver's one label if the receiver wishes to reveal the secret; and
sending to the other receivers the receiver's zero label of the receiver does not wish to reveal the secret.

20. The computer system of claim 18 wherein each receiver further:
compiles a garbled input based on labels received from the other receivers; and
executes a evaluate algorithm of the authentic garbled circuit protocol on the garbled circuit and the garbled input, the executing of the evaluate algorithm resulting in a garbled output Y.

21. The computer system of claim 20 wherein each receiver further:
attempts to decrypt the ciphertext using the garbled output Y as a decryption key.
